(19) United States
(12) Patent Application Publication
(10) Pub. No.: US 2007/0036641 A1
(43) Pub. Date: Feb. 15, 2007

(54) Cycloidal turbine

(76) Inventors: Michael McNabb, Huntsville, AL (US); James H. Boschma JR., Huntsville, AL (US)

Correspondence Address: NEIL K. NYDEGGER;NYDEGGER & ASSOCIATES, 348 Olive Street, San Diego, CA, 92103, US

(21) Appl. No.: 11/200,223

(22) Filed: Aug. 9, 2005

(51) Int. Cl. F03D 7/06

(52) U.S. Cl. 415/4.2

(57) ABSTRACT

A water turbine for generating mechanical energy from a flowing fluid includes a rigid base that can be secured at a fixed position relative to the fluid flow. On the base, a substantially disk-shaped hub is rotatably mounted and at least one blade is positioned on the hub for rotation with the hub around a hub axis. Also, each blade is rotatably mounted onto the hub for rotation of the blade relative to the hub. For the turbine, each blade defines a chord line, and for each blade, a pitch angle can be defined as the instantaneous angle between the blade's chord line and the direction of fluid flow. The turbine also includes a sprocket and chain assembly to rotationally interconnect the hub to each blade. This assembly allows the pitch angle for each blade to be selectively varied during hub rotation.

### FIELD OF THE INVENTION

The present invention pertains generally to systems and methods for converting fluid flow energy into mechanical energy. More particularly, the present invention pertains to water turbines. The present invention is particularly, but not exclusively, useful as a water turbine that is operable at relatively low head pressures.

### BACKGROUND OF THE INVENTION

A turbine can perhaps best be described as a machine in which the kinetic energy of a moving fluid is converted to mechanical power. Specifically, for the turbine, this conversion is accomplished by the impulse or reaction of the moving fluid with a series of buckets, paddles, or blades that are arrayed about the circumference of a wheel or cylinder.

One type of turbine, the water turbine, converts a portion of the kinetic energy in a flowing stream of water into mechanical energy. Typically, the water flow results from an elevational difference between the water that is upstream from the turbine and the water that is downstream from the turbine. This difference in elevation is often referred to as “head pressure” or just “head”.

One of the earliest water turbines, the simple waterwheel, was conceived of and used as far back as 2,000 years ago. The form of the mechanical power that was output from these early devices was a simple rotating shaft. This mechanical power could be used directly via belts and pulleys to power mechanical machines such as presses and pumps. Modernly, the primary use of water turbines is for the generation of electric power.

Nearly all hydroelectric power is currently generated using dams. By temporarily impeding the flow of water with a dam, a relatively large head pressure can be established. This large head pressure, in turn, can be used to produce a relatively large amount of electrical power using a water turbine. In the recent past, engineering efforts have concentrated primarily on the design of water turbines that are efficient at the relatively large head pressures that are developed using a dam.

The use of dams to create electricity is not without its disadvantages. To begin, dams can be extremely expensive to build. In addition, the construction of a dam typically has an adverse environmental impact both upstream and downstream from the dam. Specifically, this can include disruption of fragile ecosystems and a decrease in water quality.

The present invention recognizes that it may be desirable to produce electricity from the water flowing in a stream, river or tributary without the construction of a dam. This necessarily entails the efficient conversion of a relatively low head pressure fluid flow into mechanical energy.

In light of the above, it is an object of the present invention to provide a water turbine that is operable at relatively low head pressures. It is another object of the present invention to provide systems and methods for producing electricity from a stream, river or tributary without a dam. Yet another object of the present invention is to provide a water turbine which is easy to use, relatively simple to implement, and comparatively cost effective.

### SUMMARY OF THE INVENTION

The present invention is directed to a water turbine for generating mechanical energy from a fluid that can be characterized as flowing generally parallel to a flow direction. For this purpose, the water turbine includes a rigid base that can be secured at a fixed position relative to the fluid flow. On the base, a substantially disk-shaped hub is mounted for rotation about a hub axis. Typically, the hub is oriented to lie in a hub plane that is substantially perpendicular to the hub axis.

For the present invention, a plurality of elongated blades are positioned on the hub for rotation with the hub around the hub axis. Each blade is positioned at a same distance from the hub axis, and as a consequence, each blade travels on a respective blade path around the hub axis during a rotation of the hub. For the water turbine, each blade defines a respective longitudinal blade axis and has an oval cross section in a plane that is substantially normal to the blade axis. Within this plane, the blade defines a chord line which, for an oval shaped blade, is coincident with the largest dimension of the oval. Moreover, for each blade, a pitch angle can be defined as the instantaneous angle between the blade's chord line and the direction of fluid flow.

In greater structural detail, each blade is rotatably mounted on the hub for rotation about its blade axis relative to the hub. Typically, each blade is oriented on the hub with its blade axis substantially parallel to the hub axis. With this cooperation of structure, the pitch angle for each blade can be selectively adjusted during a hub rotation by rotating the blade about its blade axis.

To continuously and selectively vary each blade's pitch angle during a hub rotation, the water turbine includes a center sprocket, a plurality of blade sprockets and a chain. Each blade sprocket is mounted on a respective blade for rotation with the blade about the blade axis. In addition, each blade sprocket rotates with its respective blade and the hub around the hub axis. For the water turbine, the center sprocket is oriented on the hub for rotation with the hub about the hub axis. The chain, in turn, runs in a chain circuit that loops around the center sprocket and each blade sprocket. With this interactive cooperation of structure, each blade sprocket is rotationally interconnected with the center sprocket. Stated another way, as the hub rotates about the hub axis, the pitch angle of each blade changes.

With the above in mind, the relationship between a blade's pitch angle and the blade's position on the hub, relative to the flow direction, can now be described in greater detail. To simplify this discussion, the behavior of one blade (designated a first blade) will be analyzed with the understanding that all blades operate in a substantially similar manner. Further, for this description, it is helpful to define a radial line for the first blade wherein the radial line is a line connecting the hub axis and the blade axis of the first blade.

In use, the water turbine is positioned relative to the water flow with the hub plane (defined above) substantially parallel to the flow direction. As a consequence, each blade extends from the hub in a direction that is substantially orthogonal to the flow direction. As the water strikes the blades, the hub rotates. Consider a first hub position wherein the radial line for the first blade is normal to the flow direction and the first blade is moving generally with the direction of fluid flow. For this hub position, the sprocket and chain assembly are configured to orient the first blade with a pitch angle of approximately ninety degrees. In simpler terms, at this position, the blade is broadside to the flow.

Later, after the hub has rotated from the first hub position approximately ninety degrees, the radial line for the first blade will be parallel to the flow direction. For this position, the sprocket and chain assembly is configured to produce a pitch angle for the first blade that is approximately forty-five degrees. After yet another ninety degree rotation of the hub, the radial line for the first blade will again be normal to the flow direction, but now the first blade is moving against the direction of fluid flow. For this position, the sprocket and chain assembly is configured to orient the blade with a zero pitch angle. With this zero pitch angle, there is only minimal drag on the blade from the fluid as the blade travels against the fluid flow.

After still another ninety degrees of hub rotation, the radial line for the first blade will again be parallel to the flow direction and the pitch angle is set at approximately forty-five degrees. The above-described cycle is repeated for each rotation of the hub. As implied above, the pitch angle rotates through approximately one hundred eighty degrees during a three hundred sixty degree rotation of the hub about the hub axis.

In one embodiment of the present invention, a ramp is provided to divert water that is approaching the water turbine. Specifically, this diversion affects water in a zone near the hub where the blade is oriented at a zero-degree pitch angle. More specifically, the ramp can place the water in this zone on a somewhat circular flow pattern to enhance the efficiency of the water turbine.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded, perspective view of a cycloidal turbine in accordance with the present invention;

FIG. 2 is a schematic diagram illustrating the change in pitch angle for a single exemplary blade as that blade travels around the hub axis;

FIG. 3 is a perspective view of a turbine system having a ramp to divert water approaching the turbine blades; and

FIG. 4 is a schematic diagram illustrating the effect of a ramp on the flow of water through the turbine blades.

### DESCRIPTION OF THE PREFERRED EMBODIMENTS

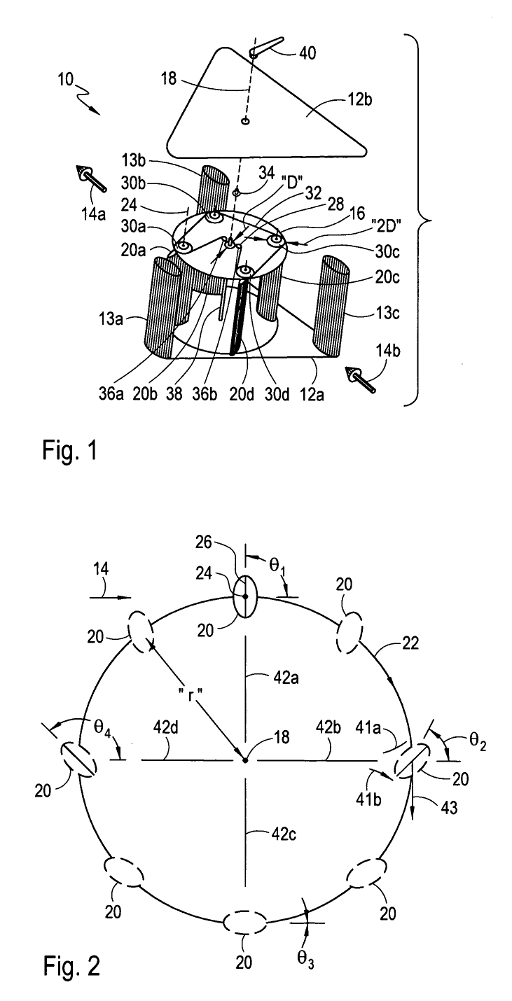

Referring initially to FIG. 1, a system for generating mechanical energy from a flowing fluid is shown and generally designated 10. As shown in FIG. 1, the system 10 includes a pair of substantially parallel rigid bases 12a,b that are held together by spacers 13a-c. The bases 12a,b can be secured at fixed positions relative to the fluid flow. For the system 10 shown in FIG. 1, the direction of fluid flow is illustrated by flow arrows 14a,b. FIG. 1 further shows that a substantially disk-shaped hub 16 is mounted on the base 12 for rotation about a hub axis 18. For the embodiment of the system 10 shown, the hub 16 is oriented to lie in a hub plane that is substantially perpendicular to the hub axis 18.

Continuing with reference to FIG. 1, it can be seen that the system 10 includes four elongated blades 20a-d. After a study of the description provided below, those artisans skilled in the pertinent art will appreciate that the embodiment shown in FIG. 1 is merely exemplary and that an operational system 10 can be constructed having more than four blades 20 and as few as one blade 20. For the system 10, each blade 20a-d is positioned on the hub 16 for rotation with the hub 16 around the hub axis 18. Also shown, each blade 20a-d is positioned at a substantially same, nonzero, radial distance, r, (see FIG. 2) from the hub axis 18.

Cross referencing FIG. 1 with FIG. 2, it can be seen that with the above-described structural arrangement, each blade 20 travels on a respective, generally circular, blade path 22 around the hub axis 18 during a rotation of the hub 16. Additionally, each blade 20 defines a respective longitudinal blade axis 24 and has a generally oval cross section in a plane that is substantially normal to the blade axis 24 and establishes a chord line 26. Moreover, as best seen in FIG. 2, a pitch angle, θ, can be defined for each blade 20. Specifically, the pitch angle, θ, is the instantaneous angle between the blade's chord line 26 and the direction of fluid flow 14.

As shown in FIG. 1, the system 10 is positioned relative to the water flow with the hub plane (defined above) substantially parallel to the flow direction 14. As a consequence, each blade 20 extends from the hub 16 in a direction that is substantially orthogonal to the flow direction 14. With this orientation, as the flowing water strikes the blades 20, the hub 16 rotates about the hub axis 18.

From FIG. 1, it can be seen that each blade 20 is rotatably mounted on the hub 16 for rotation about its respective blade axis 24 relative to the hub 16. For the embodiment of the system 10 shown, each blade 20 is oriented on the hub 16 with its respective blade axis 24 aligned substantially parallel to the hub axis 18. Thus, the pitch angle, θ, for each blade 20 can be altered by rotating the blade 20 about its blade axis 24.

Continuing with FIG. 1, it can be seen that the system 10 includes a mechanical assembly to continuously and selectively vary the pitch angle, θ, of each blade 20 during a hub rotation. Specifically, as shown, this mechanical assembly includes a central sprocket cluster 28, a plurality of blade sprockets 30a-d and a chain 32. As further shown, each blade sprocket 30a-d is mounted on a respective blade 20a-d for rotation with the respective blade 20a-d about its blade axis 24. With this structure, each blade sprocket 30a-d rotates with its respective blade 20a-d and the hub 16 around the hub axis 18.

For the system 10, the central sprocket cluster 28 includes a center sprocket 34 having a sprocket diameter, “D,” and a pair of side sprockets 36a,b which are free to rotate relative to the center sprocket 34. For the system 10, the center sprocket 34 is rotationally mounted on an alignment shaft 38 which is oriented substantially coincident with the hub axis 18. In addition, the center sprocket 34 and side sprockets 36a,b are affixed to the hub 16 and rotate with the hub 16 about the hub axis 18. The chain 32, as shown, runs in a chain circuit that loops around the center sprocket 34, side sprockets 36a,b and each blade sprocket 30a-d. With the side sprockets 36a,b, the center sprocket 34 and blade sprockets 30a-d all rotate in the same direction. The chain 32 functions to rotationally interconnect each blade sprocket 30a-d with the center sprocket 34. With this structural arrangement, the pitch angle, θ, of each blade 20 changes as the hub 16 rotates about the hub axis 18. In one implementation, blade sprockets 30 having a diameter, “2D,” are used. With this arrangement, each blade 20 rotates one hundred eighty degrees for each full rotation of the hub 16 and center sprocket 34 (Diameter “D”).

FIG. 1 also shows that the center sprocket 34 is attached to a lever 40. With this attachment, the center sprocket 34 and lever 40 rotate together about the hub axis 18. For the embodiment shown, the mechanical energy generated by the system 10 is output in the form of lever 40 rotation. This lever 40 can then be coupled, for example, to an electrical power generator (not shown) to convert the mechanical energy to electrical power.

FIG. 2 illustrates how the pitch angle, θ, of a blade 20 changes during a rotation of the hub 16 (see FIG. 1) about the hub axis 18. Specifically, FIG. 2 illustrates a single blade 20 as it rotates about the hub axis 18 and shows eight exemplary positions for the blade 20. The pitch angle, θ, is displayed for four of the eight exemplary positions shown. To further define these four selected positions, radial lines 42a-d are shown wherein each radial line 42a-d is a line connecting the hub axis 18 and the blade axis 24 at each of the respective four selected positions (i.e. the four positions where the pitch angle, θ, is displayed).

FIG. 2 shows a first position for the hub 16 (see FIG. 1) wherein the radial line 42a for the blade 20 is normal to the flow direction 14. At this first position, the blade 20, although moving along a circular blade path 22, is generally moving with the direction of flow 14. For this position, the sprocket and chain assembly (shown in FIG. 1) is configured to orient the blade 20 with a pitch angle, θ₁, of approximately ninety degrees, as shown. In simpler terms, at this position, the blade 20 is broadside to the flow direction 14.

Continuing with FIG. 2, it can be seen that after the hub 16 (see FIG. 1) has rotated approximately ninety degrees from the first position described above, the radial line 42b for the blade 20 is parallel to the flow direction 14. For this position, the sprocket and chain assembly (see FIG. 1) has operated to produce a pitch angle, θ₂, for the blade 20 that is approximately forty-five degrees, as shown. Using this position as an example, it is to be appreciated that with the pitch angle, θ₂, fluid flowing along path 41a and fluid flowing along path 41b will cooperate with the blade 20 to produce a lift type force that is oriented in the direction of arrow 43. This force acts to rotate the blade 20 about the hub axis 18. Because the pitch angle, θ, varies as the blade 20 travels around the hub axis 18, the magnitude and direction of this lift type force (illustrated by arrow 43) will vary as the blade 20 travels around the hub axis 18.

FIG. 2 further shows that after a one hundred eighty degree rotation of the hub 16 (see FIG. 1) from the first position described above, the radial line 42c for the blade 20 will again be normal to the flow direction 14. However, for this new position, the blade 20 is now moving against the direction of fluid flow 14. For this position, the sprocket and chain assembly (see FIG. 1) has operated to orient the blade 20 with a zero pitch angle, θ₃. With this zero pitch angle, θ₃, there is only minimal interaction between the blade 20 and the fluid as the blade 20 travels against the fluid flow 14.

In the fourth selected position, the hub 16 (see FIG. 1) has rotated approximately two hundred seventy degrees from the above-described first position. At this fourth position, the radial line 42d for the blade 20 is again parallel to the flow direction 14. Moreover, as shown, the sprocket and chain assembly (see FIG. 1) has operated to orient the blade 20 with a pitch angle, θ₄, that is approximately one hundred thirty-five degrees. The above-described cycle is then repeated for each rotation of the hub 16. As implied above, the pitch angle, θ, rotates through approximately one hundred eighty degrees during one full rotation of the hub 16 about the hub axis 18.

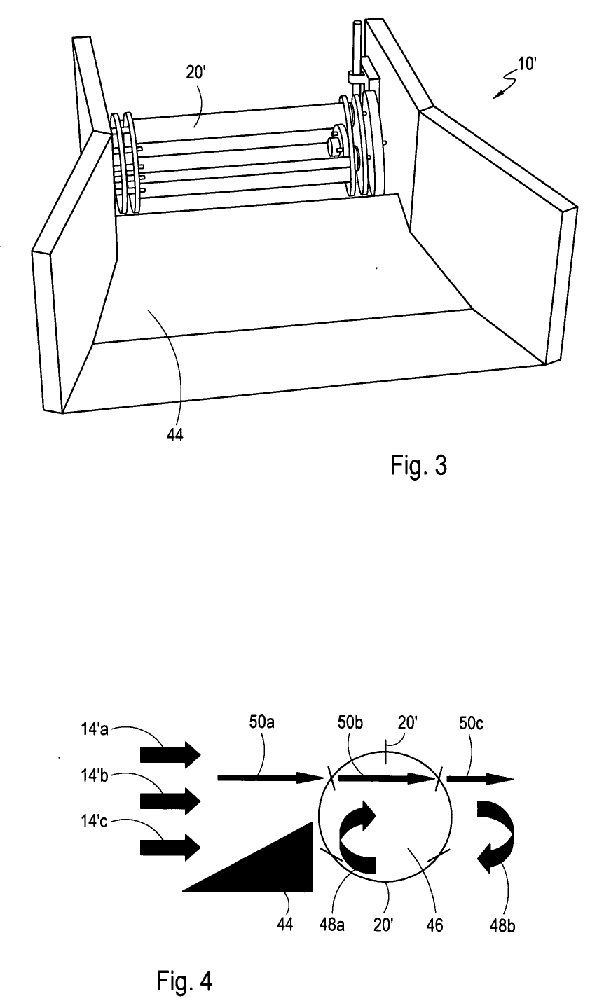

FIGS. 3 and 4 show another embodiment of the system (generally designated system 10′). As shown, for the system 10′, a ramp 44 is provided to alter the flow path of water that is approaching the blades 20′. Specifically, as best seen in FIG. 4, the ramp 44 affects water in a zone 46 proximate to the position where the blade 20′ is oriented at a zero-degree pitch angle, θ, (See also FIG. 2). More specifically, as shown, the ramp 44 can place the water in the zone 46 on a somewhat circular flow pattern, as indicated by flow arrows 48a,b. On the other hand, consider the flow near the position where blade 20′ is oriented at a ninety degree pitch angle, θ, (See also FIG. 2). At this position, as indicated by flow arrows 50a-c, the flow has an increased velocity relative to the incoming flow 14a′-c′ and is substantially parallel to the undisturbed incoming flow direction 14a′-c′. The use of the ramp 44 to create the flow patterns and increased flow velocities shown in FIG. 4 can be used to enhance the efficiency of the system 10′.

While the particular Cycloidal Turbine and corresponding methods of use as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for generating mechanical energy from a fluid flowing generally in a flow direction, said system comprising:
a base, said base being securable at a fixed position relative to the fluid flow;
a substantially disk-shaped hub mounted on said base for rotation about a hub axis, with said hub lying in a plane substantially perpendicular to the hub axis;
an elongated blade positioned on said hub for rotation therewith, wherein said blade travels on a blade path around the hub axis during rotation of said hub, said blade defining a longitudinal blade axis and a chord line substantially normal to said blade axis, and with said chord line defining a pitch angle between said chord line and the flow direction; and
a mechanical means for rotating the chord line of said blade about said blade axis to selectively vary the pitch angle of said blade during travel of said blade on said blade path.

2. A system as recited in claim 1 wherein said blade is rotatably mounted on said hub for rotation about the blade axis relative to said hub and said mechanical means comprises a coupling means for rotationally interconnecting said hub rotation with said rotation of said blade about said blade axis.

3. A system as recited in claim 2 wherein said coupling means comprises:
a blade sprocket mounted on said blade for rotation about the blade axis and for rotation with said blade around the hub axis;
a center sprocket oriented on said hub for rotation about the hub axis; and
a drive means for rotationally interconnecting said blade sprocket with said center sprocket.

4. A system as recited in claim 3 wherein said drive means is a chain.

5. A system as recited in claim 1 wherein said pitch angle is varied by approximately one hundred eighty degrees during a full rotation of said hub about the hub axis.

6. A system as recited in claim 1 wherein said blade is located along a radial line from said hub axis and said mechanical means is configured to produce a pitch angle of approximately ninety degrees when said radial line is normal to the flow direction and said blade is moving substantially in the flow direction.

7. A system as recited in claim 6 wherein said mechanical means is configured to produce a pitch angle of approximately zero degrees when said radial line is normal to said flow direction and said blade is moving substantially opposite the flow direction.

8. A system as recited in claim 1 further comprising a means for diverting fluid flow upstream of said blade.

9. A system as recited in claim 8 wherein said diverting means is a ramp.

10. A system as recited in claim 1 wherein said blade has an oval cross section in a plane normal to said blade axis.

11. A system as recited in claim 1 wherein said system comprises a plurality of said blades, each said blade having a blade axis, with each blade axis being substantially parallel to the other said blade axes.

12. A turbine for generating mechanical energy from a fluid flowing in a flow direction, said turbine comprising:
a base;
a hub mounted on said base for rotation about a hub axis;
an elongated blade positioned on said hub for rotation therewith, wherein said blade travels on a blade path around the hub axis during rotation of said hub, said blade defining a longitudinal blade axis; and
a coupling rotationally interconnecting said blade with said hub, said coupling configured to rotate said blade about the blade axis in response to a rotation of said hub about the hub axis.

13. A turbine as recited in claim 12 wherein said blade is rotatably mounted on said hub for rotation about the blade axis relative to said hub and said coupling comprises:
a blade sprocket mounted on said blade for rotation about the blade axis and for rotation with said blade around the hub axis;
a center sprocket oriented on said hub for rotation about the hub axis; and
a drive means for rotationally interconnecting said blade sprocket with said center sprocket.

14. A turbine as recited in claim 13 wherein said drive means is a chain.

15. A turbine as recited in claim 12 wherein said pitch angle is varied by approximately one hundred eighty degrees during a full rotation of said hub about the hub axis.

16. A turbine as recited in claim 12 further comprising a ramp to divert fluid flow upstream of said blade.

17. A method for generating mechanical energy from a fluid flowing in a flow direction, said method comprising the steps of:
securing a base at a fixed position relative to the fluid flow;
mounting a substantially disk-shaped hub on said base for rotation about a hub axis, with said hub lying in a plane substantially perpendicular to the hub axis;
positioning an elongated blade on said hub for rotation therewith, wherein said blade travels on a blade path around the hub axis during rotation of said hub, said blade defining a longitudinal blade axis and a chord line substantially normal to said blade axis, with said chord line defining a pitch angle between said chord line and the flow direction; and
rotating the chord line of said blade about said blade axis to vary the pitch angle of said blade during travel of said blade on said blade path.

18. A method as recited in claim 17 wherein said rotating step is accomplished with a coupling mechanism configured to rotationally interconnect said hub with said blade.

19. A method as recited in claim 17 further comprising the step of diverting fluid flow, said diversion occurring upstream of said blade.

20. A method as recited in claim 19 wherein said diverting step is accomplished with a ramp.
